(19) United States
(12) Patent Application Publication
(10) Pub. No.: US 2017/0028888 A1
(43) Pub. Date: Feb. 2, 2017

(54) SEAT SYSTEM

(71) Applicant: Johnson Controls Technology Company, Plymouth, MI (US)

(72) Inventors: Kurt SEIBOLD, Farmington Hills, MI (US); Eric B. MICHALAK, Northville, MI (US); Brennon L. WHITE, Novi, MI (US)

(21) Appl. No.: 15/302,781

(22) PCT Filed: May 22, 2015
(86) PCT No.: PCT/US15/32167

§ 371 Date: Oct. 7, 2016

Related U.S. Application Data
(60) Provisional application No. 62/003,278, filed on May 27, 2014.

(51) Int. Cl. B60N 2/64; B60N 2/56; B60N 2/68

(52) U.S. Cl. CPC B60N 2/643; B60N 2/686; B60N 2/5621

(57) ABSTRACT

A seat system having a seat back structure. The seat back structure includes a seat back structure surface. The seat back structure surface defines a plurality of corrugations. A shape of the seat back structure varies based on deflection of the plurality of corrugations.

### CROSS REFERENCE TO RELATED APPLICATIONS

This application is a United States National Phase Application of International Application PCT/US2015/032167 filed May 22, 2015 and claims the benefit of priority under 35 U.S.C. §119 and §120 of U.S. Provisional Application 62/003,278 filed May 27, 2014, the entire contents of which are incorporated herein by reference.

### FIELD OF THE INVENTION

The present invention relates to a seat system, particularly a seat system that is provided in a motor vehicle.

### BACKGROUND OF THE INVENTION

Conventional techniques for achieving a supportive, plush and compliant seat involve the use of foam. Foam only compresses a percentage of its thickness, usually less than fifty percent. This provides a design that is not space efficient and does not provide a completely sink in feel for the user.

### SUMMARY OF THE INVENTION

An object of the present invention is provide a seat back structure of a seat system that is thin, and dynamic to provide a sink in feel for a user of the seat system.

According to the invention, a seat system comprises a seat back structure. The seat back structure comprises a seat back structure surface. The seat back structure surface defines a plurality of corrugations. A shape of the seat back structure varies based on deflection of the plurality of corrugations.

The seat back structure may comprise a first seat back structure position and a second seat back structure position. The seat back structure surface may comprise a first lateral length in the first seat back structure position. The seat back structure surface may comprise a second lateral length in the second seat back structure position.

Each of the corrugations may have a user contact portion. The user contact portion of one of the corrugations may be located at a first distance from the user contact portion of another one of the corrugations in the first seat back structure position. The user contact portion of one of the corrugations may be located at a second distance from the user contact portion of another one of the corrugations in the second seat back structure position. The first distance may be less than the second distance.

At least a portion of the seat back structure may move in a rearward direction when the seat back structure moves from the first seat back structure position to the second seat back structure position.

The seat system may further comprise a seat back frame. The seat back structure may be connected to the seat back frame. The seat back structure may be a single, one-piece panel.

The seat system may further comprise a suspension system connected to the seat back structure. The deflection of the corrugations may vary based on the suspension system.

The seatback structure may comprise vertical sections. The suspension system may comprise an elongating system. The vertical sections may move from a first state to a second state as the suspension system elongates.

The suspension system may comprise a plurality of leaf springs and at least one wire. The deflection may be based on at least a tension of the at least one wire and a resistance of the plurality of leaf springs.

The suspension system may comprise a sinusoidal suspension system. The seatback structure surface may comprise vertical members. The deflection of the vertical members may be based on bending of sinusoidal wires.

A tertiary component may be placed laterally of the seat back structure to control movement of vertical members of the seat back structure in a rearward direction. Forces may not be applied to the tertiary component unless the forces exceed seat input forces.

The tertiary component may provide a bending movement. The bending movement may control displacement of the vertical members.

The tertiary component may provide a tension. Tensile forces associated with the tertiary component may control displacement of the vertical members.

The seat back structure may comprise a user contact surface and a rear surface. The user contact surface may be opposite the rear surface. At least a portion of the suspension system may be located adjacent to the rear surface.

The suspension system may comprise a plurality of suspension members. Each of the leaf springs may be arranged between one of the plurality of suspension members and another one of the plurality of suspension members.

The plurality of leaf springs may comprise a plurality of first leaf springs and a plurality of second leaf springs. The first leaf springs may be associated with the at least one tension adjustment means. The suspension system may comprise another tension adjustment means for adjusting a tension of the second leaf springs.

The seat back structure may comprise a heating element.

The seat back structure may comprise a strain gage.

The seat back structure may comprise electro active polymers.

The seat back structure surface may define a plurality of ducts. The ducts may provide an airflow path in a heated and cooled seat.

According to the invention, a seat system comprises a seat back structure. The seat back structure comprises a plurality of interlinking sections and a plurality of vertically oriented sections. Each of the vertically oriented sections is located at a spaced location from another one of the plurality of vertically oriented sections. The plurality of interlinking sections provide a translational relationship between the vertically oriented sections.

The seat back structure may comprise a user occupied seat back structure configuration and a user unoccupied seat back configuration. The seat back structure may comprise a first lateral length in the user unoccupied seat back configuration. The seat back structure surface may comprise a second lateral length in the user occupied seat back configuration.

The seat system may further comprise a suspension system that is connected to the seat back structure.

The suspension system may be an elongating system. The vertically oriented sections may move from a first state to a second state as the suspension system elongates.

The suspension system may comprise a plurality of leaf springs and at least one wire. A deflection of the vertically oriented sections may be based on at least a tension of the at least one wire.

The suspension system may comprise a sinusoidal suspension system. A deflection of the vertically oriented sections may be based on bending of sinusoidal wires.

A tertiary component may be placed laterally to the seat back structure to control a rearward movement of the vertically oriented sections. Forces may not be applied to the tertiary component unless the forces exceed seat input forces.

The tertiary component may provide a bending movement. The bending movement may control displacement of the vertically oriented sections.

The seat system may further comprise a seat back frame. The seat back structure may be connected to the seat back frame. The seat back structure may be a single, one-piece seat back structure.

According to the invention, a seat system comprises a seat back frame. A single, one-piece seat back structure is connected to the seat back frame. The single, one-piece seat back structure comprises a seat back structure surface. The seat back structure surface comprises a plurality of user engaging portions. Each of the user engaging portions is located at a spaced location from another one of the user engaging portions. The seat back structure comprises an unoccupied seat back structure position and an occupied seat back structure position. The seat back structure surface comprises a first lateral length in the unoccupied seat back structure position. The seat back structure surface comprises a second lateral length in the occupied seat back structure position. The second lateral length is greater than the first lateral length.

The seat system may further comprise a suspension system connected to the seat back structure. The suspension system may comprise a plurality of leaf springs and a plurality of wires. A deflection of the seat back structure surface may be based on at least a resistance provided by the leaf springs and a tension of the plurality of wires.

The seat back structure surface may be in a non-stretched configuration with the seat back structure in the unoccupied seat back structure position. The seat back structure surface may be in a stretched configuration with the seat back structure in the occupied seat back structure position.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a perspective view of a seat system of the present invention;

FIG. 2 is a partial rear view of the seat system;

FIG. 3 is a partial perspective view of the seat system;

FIG. 4 is an enlarged view of the seat system;

FIG. 5 is another perspective view of the seat system;

FIG. 6 is a partial sectional view of a seat back structure of the seat system;

FIG. 7 is another partial perspective view of the seat system;

FIG. 8 is yet another perspective view of the seat system;

FIG. 9 is yet another perspective view of the seat system;

FIG. 10 is a rear perspective view of the seat system;

FIG. 11 is a top view of the seat system prior to a user engaging the seat back structure;

FIG. 12 is a top view of the seat system after the user has engaged the seat back structure;

FIG. 13 is a perspective view of a suspension system of the seat system;

FIG. 14 is a partial perspective view of a mechanism of the suspension system;

FIG. 15 is an enlarged view of a stop element of the suspension system;

FIG. 16 is a perspective view of the suspension system of the seat system;

FIG. 17 is another top view of the seat system;

FIG. 18 is a view showing a panel affixed to a composited structure; and

FIG. 19 is a sectional view of a suspension system.

### DESCRIPTION OF THE PREFERRED EMBODIMENTS

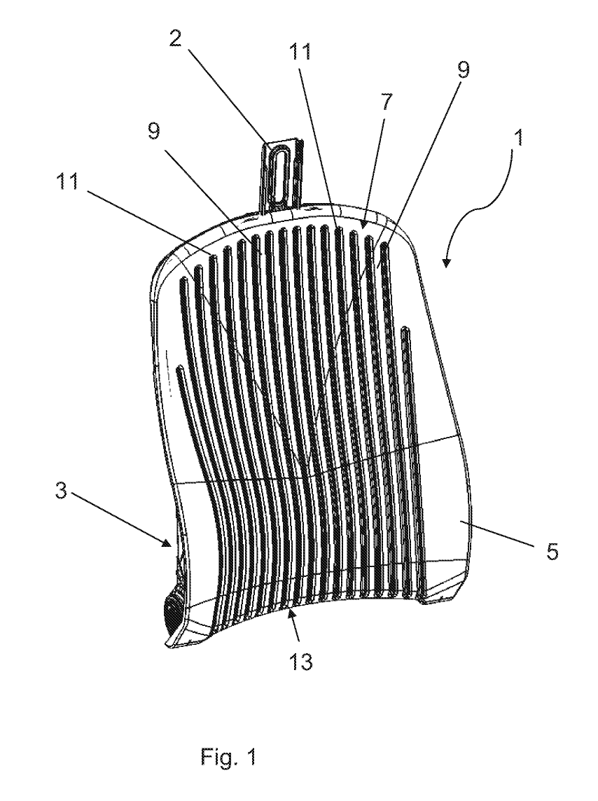

Referring to the drawings in particular, FIG. 1 is a perspective view of a seat system 1. The seat system 1 includes a seat back structure (panel) 5 that is connected to a seat frame 3. A headrest connecting structure 2 is connected to the seat frame 3. The headrest connecting structure 2 allows a headrest to be connected to the seat frame 3. The seat back structure 5 is formed of a one-piece panel that has a corrugated surface 7. The corrugated surface 7 includes a plurality of vertically oriented members 9. The vertically oriented members 9 define a contact surface 13 for contacting a user of the seat back structure 1. The vertically oriented members 9 are connected by interlinking sections 11. The interlinking sections 11 allow the contact surface 13 to change to allow the contact surface 13 to become longer laterally and move rearward when the seat back structure 1 is occupied (loaded) by a user of the seat system 1. This provides a sink in feel when the user sits in the seat back structure 5.

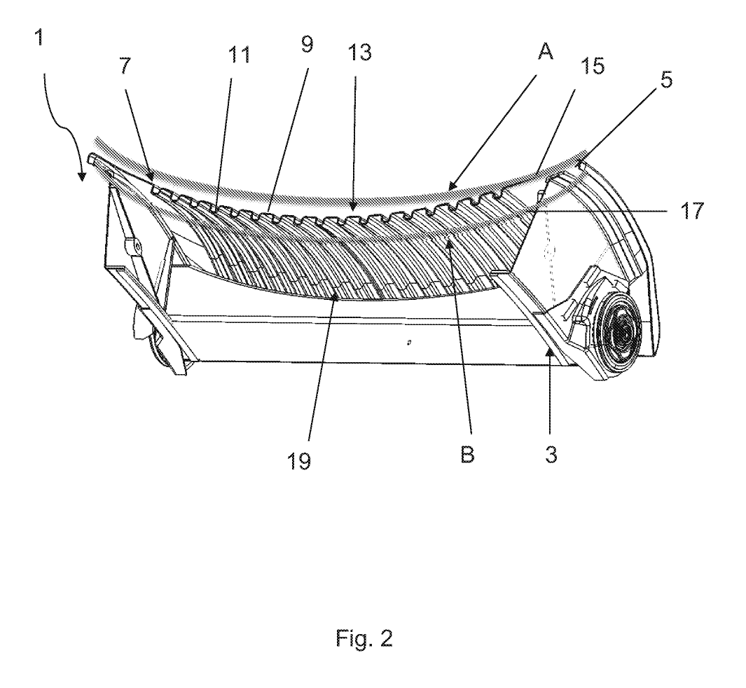

FIG. 2 is a partial rear view of the seat system 1. The seat back structure 5 is shown in an unoccupied position A and an occupied position B. In position A, the contact surface 13 has a first length 15. In position B, the contact surface 13 has a second length 17. The second length 17 of the contact surface 13 is greater than the first length 15 of the contact surface 13. The rate (resistance) for the seat back structure 1 to go from position A to position B can be brought about by the material of the seat back structure 5 itself or from an additional support member. Loading for the seat back structure 5 or the support member is centered on a lumbar area 19. If the support member is not used, cutouts (not shown) may be made in the corrugated surface 7 to reduce stress on the seat back structure 5 and to focus loading in the lumber area 19. The cutouts in the corrugated surface 7 may also be applied if the support member is used.

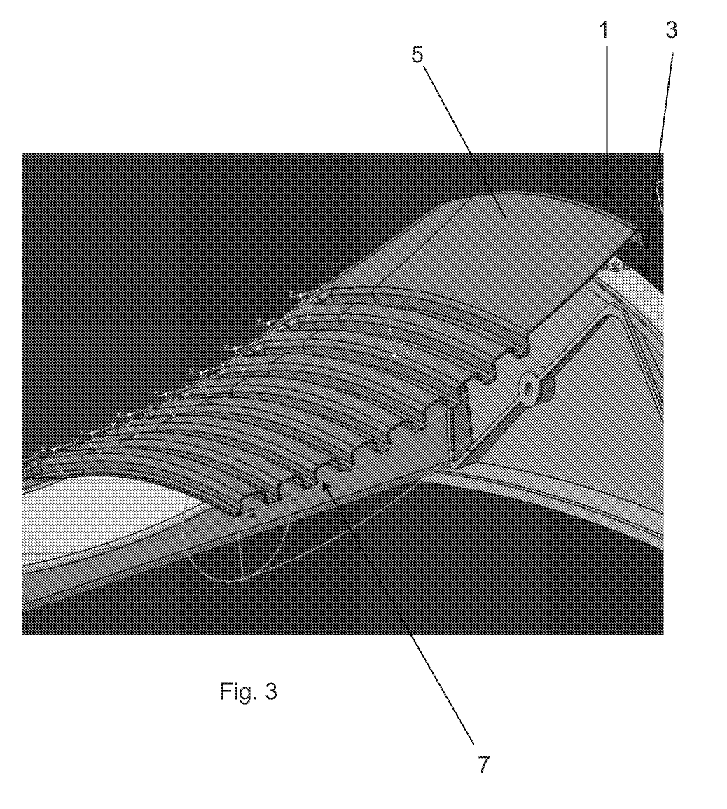

FIG. 3 is a partial perspective view of the seat system 1. The seat back structure 5 may include no foam. In another embodiment, the seat back structure 5 may be formed with a limited amount of foam. The seat back structure 5 may be formed of thermoplastic polyurethane or another semi-compliant material. The panel may also be made from a thermoplastic elastomer that allows the corrugations to recoil to their original state and resist loading thereby creating a predefined suspension rate. This allows the panel to become not only a supporting surface but also a suspension member. The corrugated surface 7 may be formed in the seat back structure 5 by injection molding or by any other suitable process.

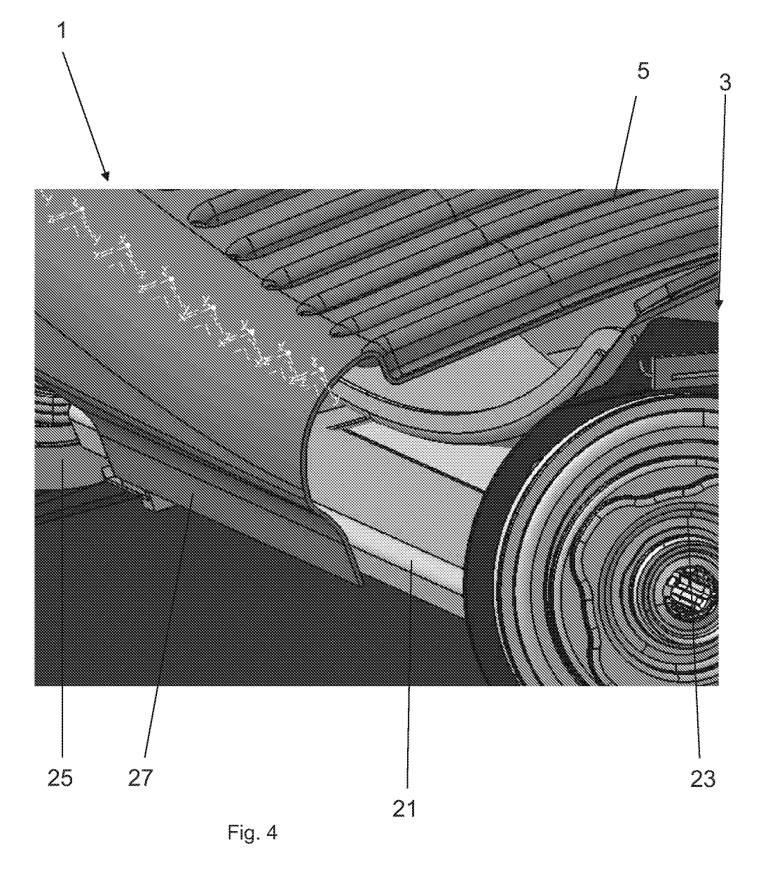

FIG. 4 is an enlarged view of the seat system 1 in a lower area of the seat frame 3. The seat frame 3 has a connecting member 21. The connecting member 21 is connected to a first seat frame portion 23 and a second seat frame portion 25. The seat back structure 5 includes a seat back structure portion 27. The seat back structure portion 27 is attached to the seat frame 3 at the back of the seat frame 3. It is understood that other portions of the seat back structure 5 can be connected to the seat frame 3 in a similar manner. This improves trim out and allows a lower area of the seat back structure 5 to deflect with a perpendicular load applied to the seat back structure 5 by the user.

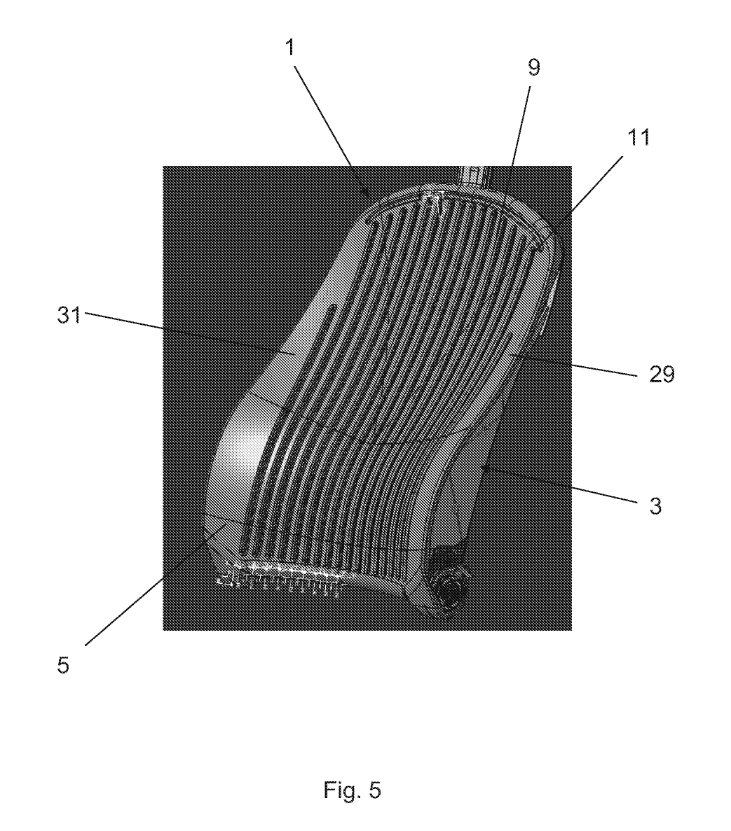

FIG. 5 is a perspective view of the seat system 1. The seat back structure 5 has a first side bolster 29 and a second side bolster 31. A stiffness (compliance ratio) of the first side bolster 29 and the second side bolster 31 can be tuned to meet a rate determined most beneficial to an occupant.

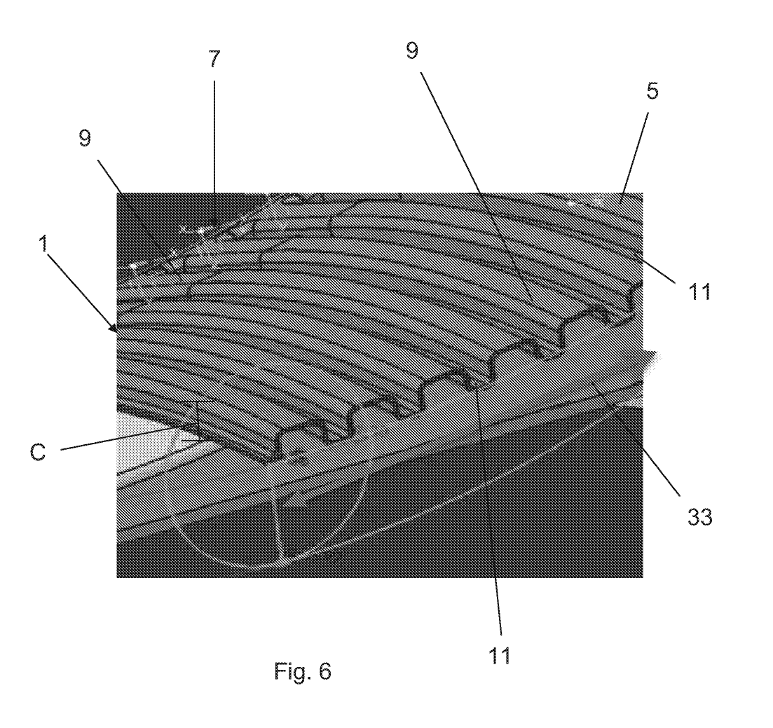

FIG. 6 is a partial sectional view of the seat back structure 1. Each interlinking section 11 is located at a position that is below a position of each vertically oriented member 9. Each interlinking section 11 extends in an area between two vertically oriented members 9. The seat back structure 5 is able to stretch in a lateral direction 33 based on one or more of the material thickness of the seat back structure 5, material properties of the seat back structure 5, the depth c of the interlinking sections 11 and localized cutouts in the corrugated surface 7. The depth c is defined as the distance between a location of one of the interlinking sections 11 and a location of one of the vertically oriented member 9. When the seat back structure 5 is stretched (the seat back structure 5 stretches in an accordion-like manner when occupied by a user), a distance increases between each vertically oriented member 9 and another one of the vertically oriented members 9. Alterations to these sections can alter the stiffness of the panel and the rate at which it resists change. The addition of local changes can change the rate locally to tune the resistance as it rises up the back.

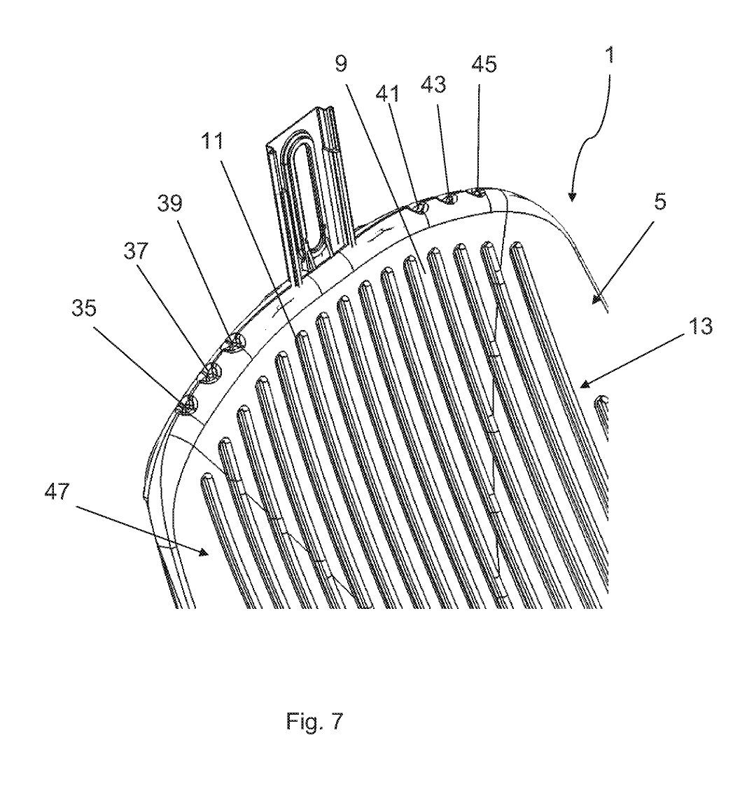

FIG. 7 is a partial perspective view of the seat system 1. The seat back structure 5 interacts at one or more locations 35, 37, 39, 41, 43, 45 with the seat frame 3. The locations 35, 37, 39, 41, 43, 45 are offset from the contact surface 13. This allows deflection of the contact surface 13 such that no area of the contact surface 13 is restricted from deflection, which is of particular importance in a shoulder region 47 of the seat back structure 5. If designed for manufacture by injection molding ribs may be used to allow deflection thereby creating an energy management system.

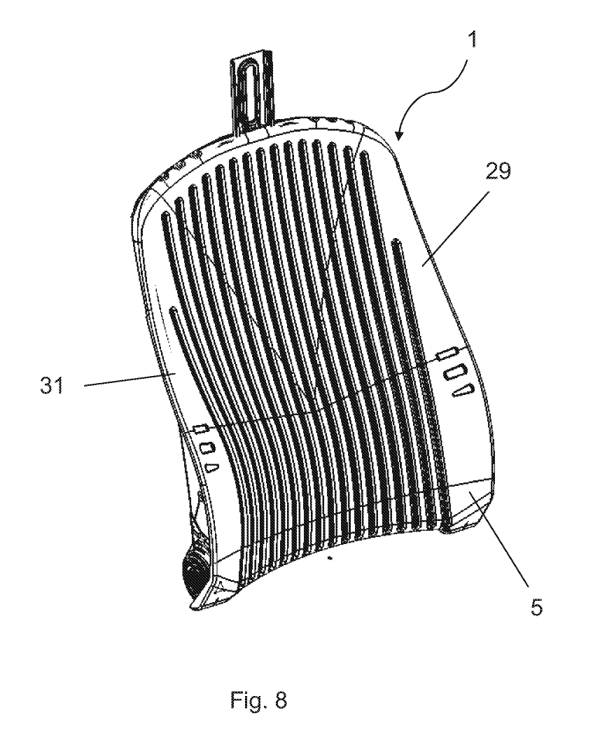

FIG. 8 is a perspective view of the seat system 1. By changing section properties of the seat back structure 5 at locations where the seat back structure 5 is connected to the seat frame 3, a stiffness of the bolsters 29, 31 can be altered. A stiffness (compliance ratio) of the first side bolster 29 and the second side bolster 31 is determined based on the section properties of stiffening members going inward or outward from corresponding affixing points shown horizontally. The shape and location of the stiffening members can be tuned to meet a rate determined most beneficial to an end consumer. Construction can be ribs, beads or any means known to create a stiffening and distributing section. A constant stiffness may be provided along an edge of the bolsters 29, 31.

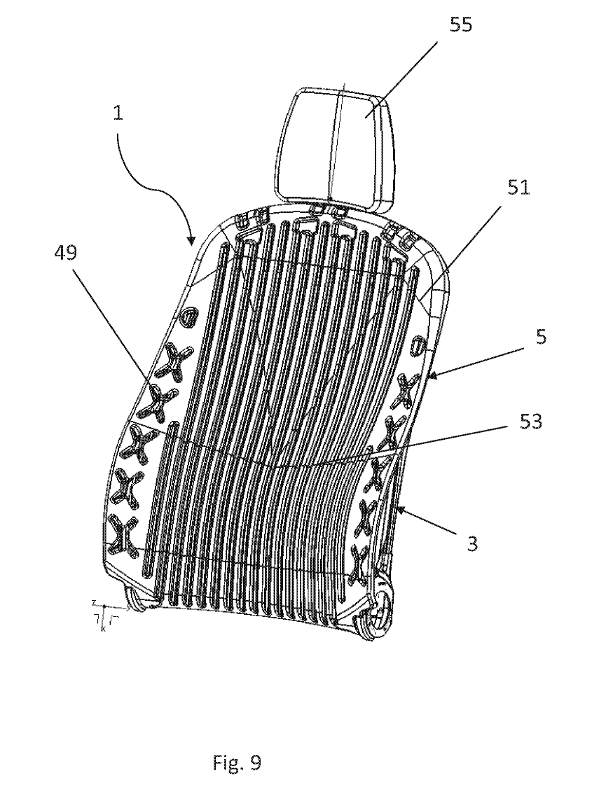

FIG. 9 is another perspective view of the seat system 1. A headrest structure 55 is connected to the seat frame 3. Printing circuitry is connected to the seat back structure 5. The printing circuitry may provided over the seat back structure 5. The seat back structure 5 may be formed of one sheet of polymer and the printing circuitry may be printed on the polymer. It is also possible that the seat back structure 5 is formed of two or more sheets of polymer and the printed circuitry may be provided on the two or more sheets of polymer. A heating element 49 is connected to the seat back structure 5. A strain gage 51 is connected to the seat back structure 5. Any number of heating elements and strain gages 51, 53 may be connected to the seat back structure 5. The heating element 49 and the strain gage 51 may be printed on the seat back structure 5. The seat back structure 5 may be provided with an electro active polymer. The electro active polymer provides the seat back structure 5 with haptic and massage features. The electro active polymer allows a user to become aware of a vehicle in a blind spot of a user's vehicle by providing stimulative feedback, such as a buzzing feature. The electro active polymer also allows for a driving stimulant to give feedback from an engine of the user's vehicle and/or driving dynamics. Though shown as preprocessed prior to forming, these additions could be adhered to the panel if injection molding or another process is involved.

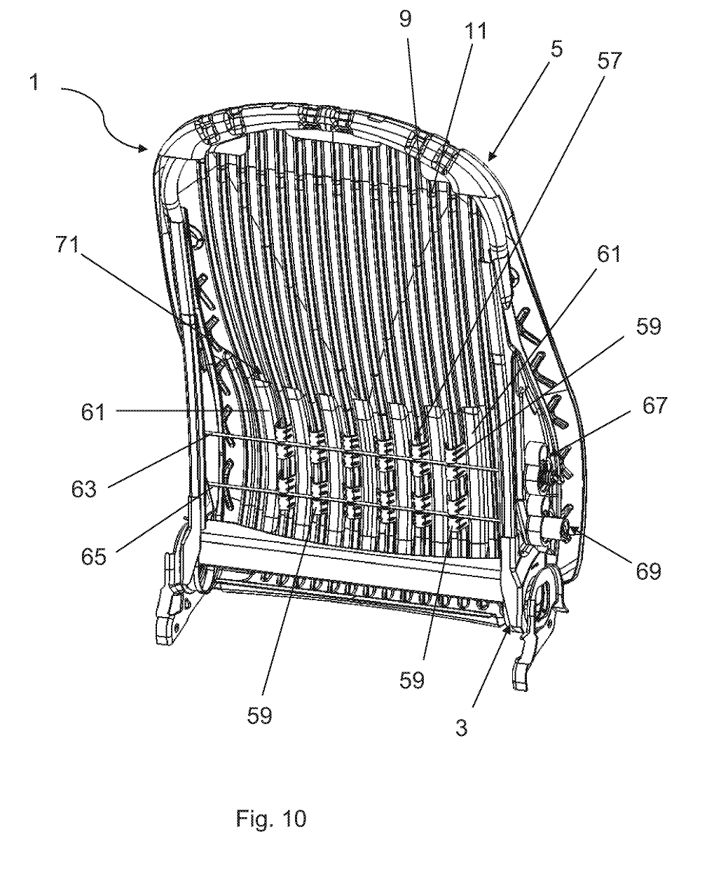

FIG. 10 is a rear perspective view of the seat system 1. The seat system 1 includes a suspension structure 57. The suspension structure 57 is connected to the seat frame 3. The suspension structure 57 is arranged opposite a lumbar region 71 of the seat back structure 5. The suspension structure 57 has a plurality of springs 59, a plurality of vertically extending suspension members 61 and two wires 63, 65. The springs 59 and the two wires 63, 65 may be made of steel. The vertically extending suspension members 61 may be made of a thermoplastic elastomer. It is also possible that the springs 59 may be formed of a thermoplastic elastomer. The wires 63, 65 are connected to the seat frame 3. The wires 63, 65 and the springs 59 form a leaf spring system. Each spring 59 is provided between one of the vertically extending suspension members 61 and another one of the vertically extending suspension members 61. A first mechanism 67 is associated with one of the wires 63 for adjusting a tension of the wire 63. A second mechanism 69 is associated with another one of the wires 65 for adjusting a tension of the wire 65. The first mechanism 67 and the second mechanism 69 are located on a side of the seat frame 3. A deflection of the seat back structure 5 is varied based on the tension of the wires 63, 65. Bending of the wires 63, 65 controls displacement of the vertically extending suspension members 61. Bending of the wires 63, 65 also controls the deflection of the seat back structure 5. In another embodiment, it is possible to use only one wire and one mechanism for adjusting the tension of the one wire. In another embodiment, it is possible incorporate the springs 59 and suspension members 61, which form a basket, into the panel, which is beneficial if the panel is constructed from a thermoplastic elastomer.

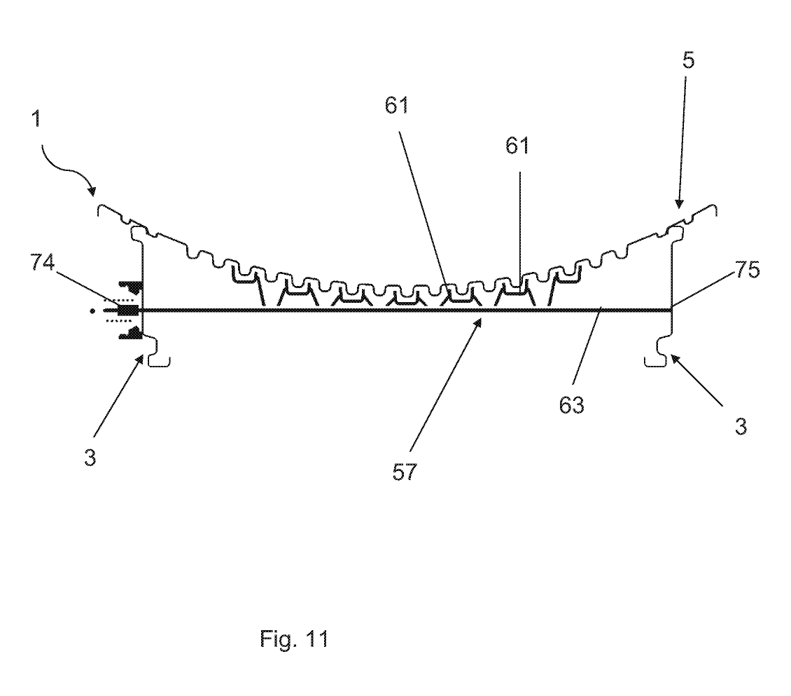

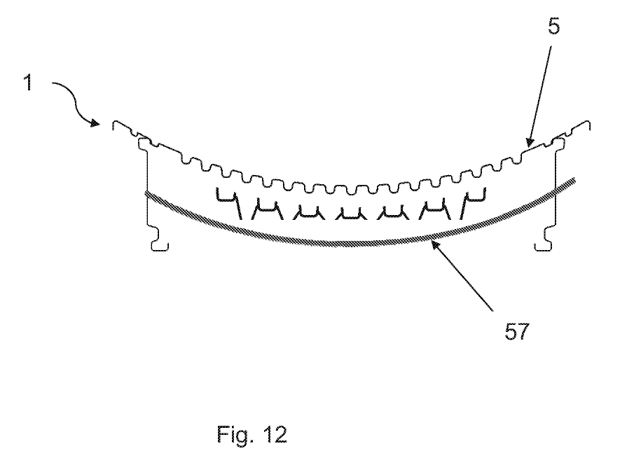

FIG. 11 is a top view of the seat system 1 prior to a user engaging the seat back structure 5. The wire spring 63 extends from one side of the seat frame 3 to another side of the seat frame 3. A stop element 74 is located on one side of the seat frame 3. Another stop element 75 may be provided on another side of the seat frame 3. As a user sits in the seat back structure 5, the seat back structure 5 deflects and pushes the suspension structure 57 in a rearward direction until resistance in the suspension structure 57 reaches an equilibrium. FIG. 12 is a top view of the seat system 1 after a user has engaged the seat back structure 5.

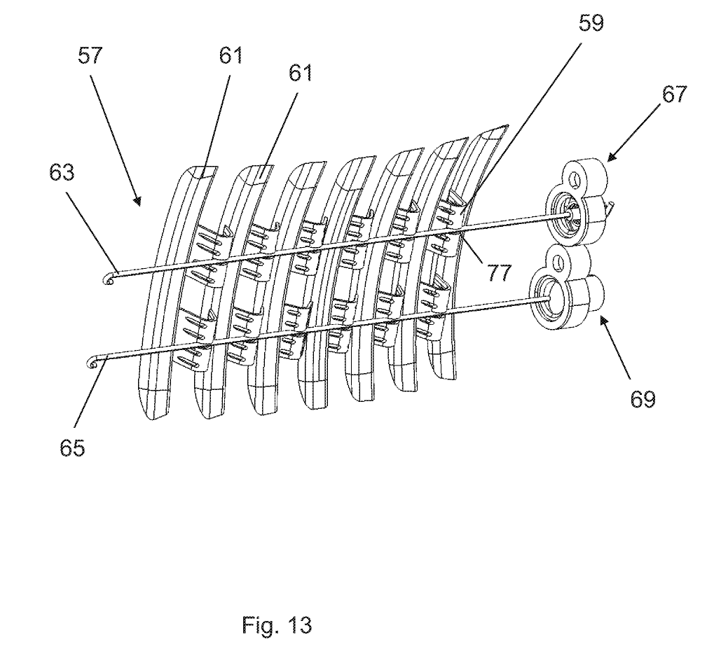

FIG. 13 is a perspective view of the suspension system 57. Each spring 59 has a slot 77. A first group of springs 59 are associated with the wire spring 63. The wire spring 63 extends through the slot 77 of each spring 59 associated with the first group of springs 59. A second group of springs 59 are associated with the wire spring 65. The wire 65 extends through the slot 77 of each spring 59 associated with the second group of springs 59. The first mechanism 67 and the second mechanism 69 are located laterally with respect to the suspension members 61. Shown are two systems, but there could one or any plurality of systems.

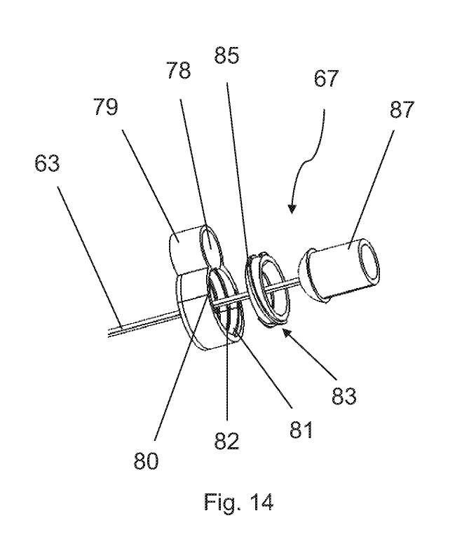

FIG. 14 is a partial perspective view of the first mechanism 67. The second mechanism 69 is formed of the same components of the first mechanism 67 and is not discussed to avoid repetition. The first mechanism 67 includes a housing 79. The housing 79 has a first opening 78 for receiving a connecting element for connecting the housing 79 to the seat frame 3. The housing 79 has a surface 81 defining a plurality of threads 82 and a second opening 80. A tension adjustment element 83 has a plurality of threads 85 that cooperate with the threads 82 to rotatably connect the tension adjustment element 83 to the housing 79. The tension adjustment element 83 is arranged in the second opening 80 when the tension adjustment element 83 is fastened to the housing 79. An element 87 is connected to one end of the wire spring 63. By rotating the tension adjustment element 83 in a first direction, a distance the wire spring 63 must travel from bending to tension is reduced and a spring 89 and/or a stop compliant element 91 goes into compression. By rotating the tension adjustment element 83 in a second direction, which is opposite to the first direction, the distance the wire spring 63 must travel from bending to tension is increased and the spring 89 and/or the stop compliant element 91 goes into compression. The purpose of the adjustable system is to alter a profile of the seat shape along the spine.

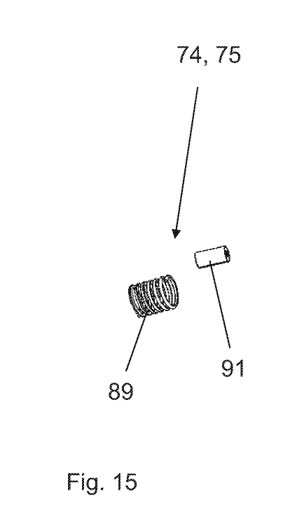

FIG. 15 is an enlarged view of the stop element 74 and the stop element 75. In one embodiment, the stop element 74 and the stop element 75 include the spring 89. In another embodiment, the stop element 74 and the stop element 75 include the stop compliant element 91. The stop compliant element 91 may be formed of elastomer. In another embodiment, one of the stop elements includes the spring and another one of the stop elements includes the stop compliant member 91. The purpose of these secondary compressive elements 89, 91 is to create a dual rate system so it does not abruptly come to a stop when an occupant overloads the seat system.

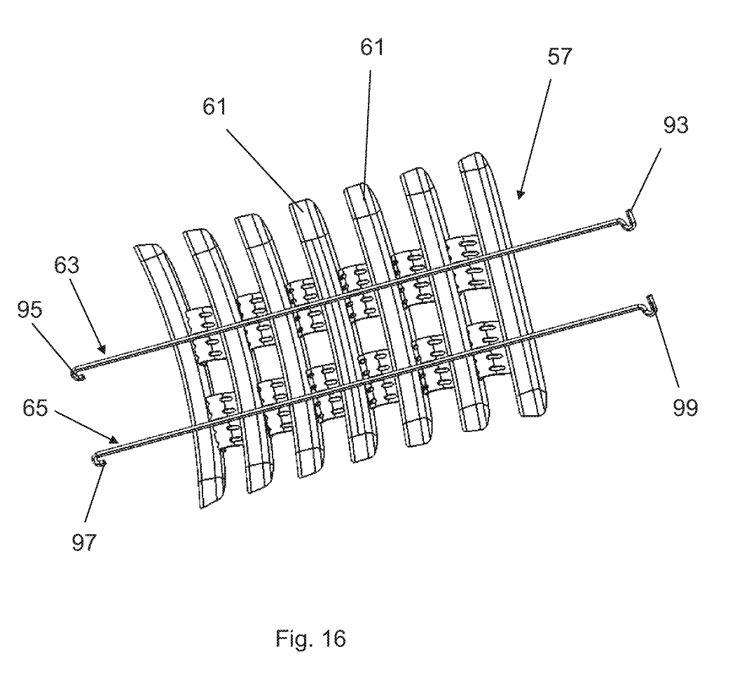

FIG. 16 is a perspective view of the suspension system 57. The wire 63 has compliant end stops 93, 95, which include bent portions of the wire 63. The wire 65 has compliant end stops 97, 99, which include bent portions of the wire 65. The compliant end stops 93, 95, 97, 99 allow for a secondary rate of deflection of the vertically oriented members 9. In another embodiment, it is possible to integrate the vertically extending suspension members 61 in the seat back structure 5.

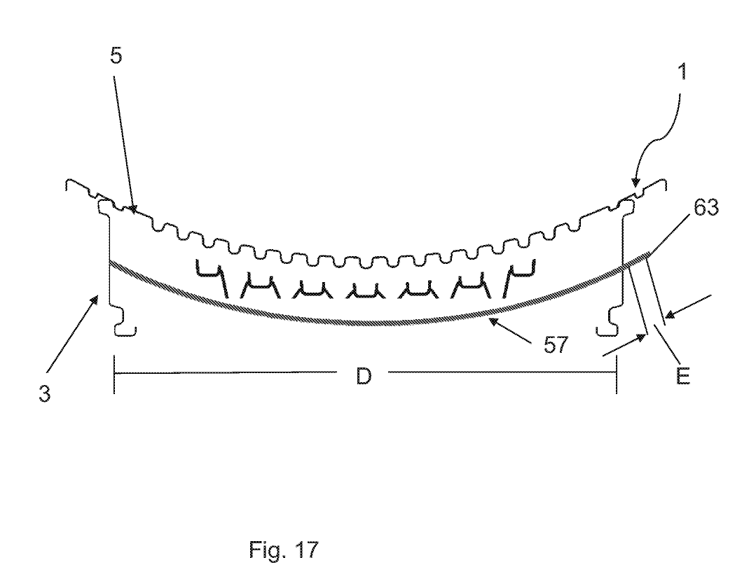

FIG. 17 is a top view of the seat system 1. The wires 63, 65 span a distance D. The distance D is about 400 mm. The targeted sink in (the amount of deflection of the seat back structure in the rearward direction) of a user is 25-40 mm. The stop element 74 and/or the stop element 75 can be deflected by a distance E in a lateral direction, which allows the suspension system 57 to deflect in a rearward direction. The stop element 74 and the stop element 75 allow for the suspension system 57 to go into tension, which provides high strength capability for overload and abuse. A stop position of the suspension system 57 is provided by the stop element 74 and the stop element 75. The stop position can be changed by the stop element 74 and the stop element 75, which changes the contour of the seat back structure 5.

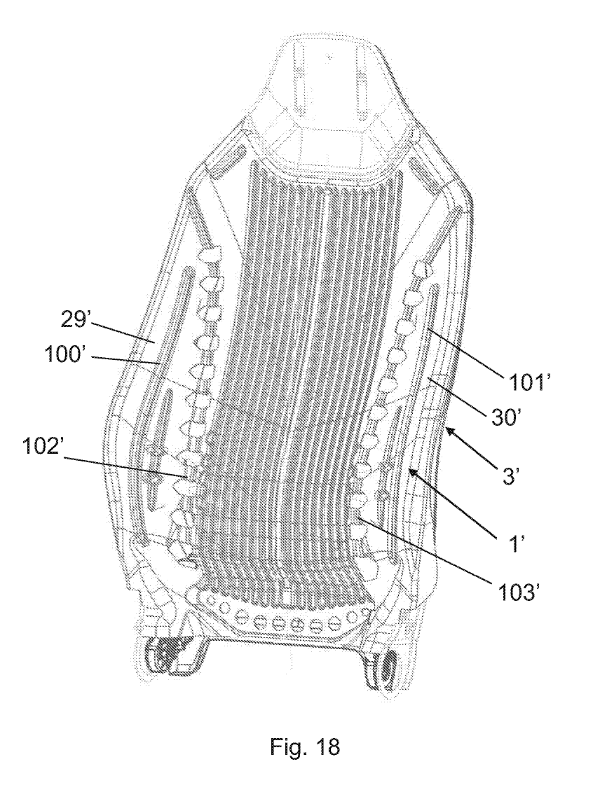

FIG. 18 shows a back panel 1′ developed for a composite frame structure 3′. Offset attachments 100′, 101′ to the frame 3′ allows a compressive deflection of bolsters 29′, 31′. Grooves 102′,103′ provide the ability to package a fabric or leather trim seam common on seatback construction. This seam location allows trim deflection at a critical point on the seat without foam to compress.

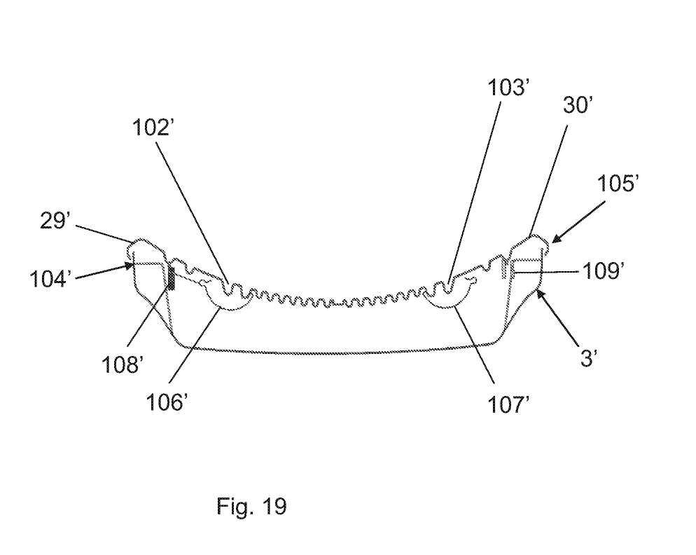

FIG. 19 is a cross section view of the composite frame structure 3′. The composite frame structure 3′ has a stop feature 104′, 105′ to limit deflection of bolsters 29′, 30′ to limit stress in the panel P. The suspension system is a series arrangement where spring members 106, 107 supplement resistance of the grooves 102′, 103′. The panel is affixed to the frame 3′ at locations 108,109.

While specific embodiments of the invention have been shown and described in detail to illustrate the application of the principles of the invention, it will be understood that the invention may be embodied otherwise without departing from such principles.

1. A seat system comprising:
a seat back structure comprising a seat back structure surface, said seat back structure surface defining a plurality of corrugations, wherein a shape of said seat back structure varies based on deflection of said plurality of corrugations.

2. A seat system in accordance with claim 1, wherein said seat back structure comprises a first seat back structure position and a second seat back structure position, said seat back structure surface comprising a first lateral length in said first seat back structure position, said seat back structure surface comprising a second lateral length in said second seat back structure position, said first lateral length being less than said second lateral length.

3. A seat system in accordance with claim 1, wherein each of said corrugations has a user contact portion, said user contact portion of one of said corrugations being located at a first distance from said user contact portion of another one of said corrugations in said first seat back structure position, said user contact portion of said one of said corrugations being located at a second distance from said user contact portion of said another one of said corrugations in said second seat back structure position, wherein said first distance is less than said second distance.

4. A seat system in accordance with claim 1, wherein at least a portion of said seat back structure moves in a rearward direction when said seat back structure moves from said first seat back structure position to said second seat back structure position.

5. A seat system in accordance with claim 1, further comprising:
a seat back frame, said seat back structure being connected to said seat back frame, said seat back structure being a single, one-piece panel.

6. A seat system in accordance with claim 5, further comprising:
a suspension system connected to said seat back structure, said deflection of said corrugations varying based on said suspension system.

7. A seat system in accordance with claim 6, wherein said seatback structure comprises vertical sections, said suspension system comprising an elongating system, whereby said vertical sections move from a first state to a second state as said suspension system elongates.

8. A seat system in accordance with claim 6, wherein said suspension system comprises a plurality of leaf springs and at least one wire, wherein said deflection is based on at least a tension of said at least one wire and a resistance of said plurality of leaf springs.

9. A seat system in accordance with claim 6, wherein said suspension system comprises a sinusoidal suspension system, said seatback structure surface comprising vertical members, wherein said deflection of said vertical members is based on bending of sinusoidal wires.

10. A seat system in accordance with claim 1, wherein a tertiary component is placed laterally of said seat back structure to control movement of vertical members of said seat back structure in a rearward direction, wherein forces are not applied to said tertiary component unless said forces exceed seat input forces.

11. A seat system in accordance with claim 10, wherein said tertiary component provides a bending movement, wherein said bending movement controls displacement of said vertical members.

12. A seat system in accordance with claim 10, wherein said tertiary component provides a tension, wherein tensile forces associated with said tertiary component controls displacement of said vertical members.

13. A seat system in accordance with claim 9, wherein said seat back structure comprises a user contact surface and a rear surface, said user contact surface being opposite said rear surface, at least a portion of said suspension system being located adjacent to said rear surface.

14. A seat system in accordance with claim 8, wherein said suspension system comprises a plurality of suspension members, each of said leaf springs being arranged between one of said plurality of suspension members and another one of said plurality of suspension members.

15. A seat system in accordance with claim 8, wherein said plurality of leaf springs comprises a plurality of first leaf springs and a plurality of second leaf springs, said first leaf springs being associated with said at least one tension adjustment means, said suspension system comprising another tension adjustment means for adjusting a tension of said second leaf springs.

16. A seat system in accordance with claim 1, wherein said seat back structure comprises one or more of a heating element, a strain gage and electro active polymers, said seat back structure surface defining a plurality of ducts, said ducts providing an airflow path in a heated and cooled seat.

17-19. (canceled)

20. A seat system, comprising:
a seat back structure comprising a plurality of interlinking sections and a plurality of vertically oriented sections, each of said vertically oriented sections being located at a spaced location from another one of said plurality of vertically oriented sections, wherein said plurality of interlinking sections provide a translational relationship between said vertically oriented sections.

21-28. (canceled)

29. A seat system, comprising:
a seat back frame;
a single, one-piece seat back structure connected to said seat back frame, said single, one-piece seat back structure comprising a seat back structure surface, said seat back structure surface comprising a plurality of user engaging portions, each of said user engaging portions being located at a spaced location from another one of said user engaging portions, wherein said seat back structure comprises an unoccupied seat back structure position and an occupied seat back structure position, said seat back structure surface comprising a first lateral length in said unoccupied seat back structure position, said seat back structure surface comprising a second lateral length in said occupied seat back structure position, said second lateral length being greater than said first lateral length.

30. A seat system in accordance with 29, further comprising:
a suspension system connected to said seat back structure, said suspension system comprising a plurality of leaf springs and a plurality of wires, wherein a deflection of said seat back structure surface is based on at least a resistance provided by said leaf springs and a tension of said plurality of wires.

31. A seat system in accordance with claim 29, wherein said seat back structure surface is in a non-stretched configuration with said seat back structure in said unoccupied seat back structure position, said seat back structure surface being in a stretched configuration with said seat back structure in said occupied seat back structure position.
